(19) United States
(12) Patent Application Publication
(10) Pub. No.: US 2022/0382824 A1
(43) Pub. Date: Dec. 1, 2022

(54) BROWSER SEARCH MANAGEMENT

(71) Applicant: International Business Machines Corporation, Armonk, NY (US)

(72) Inventors: Yasumasa Kajinaga, Funabashi (JP); Tohru Hasegawa, Tokyo (JP); SHUNSUKE ISHIKAWA, Tokyo (JP); DAIKI TSUZUKU, Kawasaki (JP); Masaki Komedani, Yokohama (JP); KEISUKE NITTA, Koshigaya (JP)

(21) Appl. No.: 17/331,880

(22) Filed: May 27, 2021

(51) Int. Cl. G06F 16/957; G06F 16/953; G06F 16/2457; G06F 16/906

(52) U.S. Cl. CPC G06F 16/9574; G06F 16/953; G06F 16/24578; G06F 16/906

(57) ABSTRACT

A search initiated by a user within an internet browsing application using a search phrase can be detected. A similarity between the search phrase and each of one or more existing groups can be determined, each of the one or more existing groups including one or more saved web pages. An existing group of the one or more existing groups can be selected based on the determined similarity. A current browsed web page returned from the search can be obtained, and the current browsed web page can be added to the existing group.

### BACKGROUND

The present disclosure relates generally to the field of computing, and in particular, to browser search history management.

Currently, within internet browsers, bookmarks are used to save frequently accessed and/or important websites/web pages. Upon navigating to a particular web page, the user can “bookmark” the page by clicking an icon such that the page is saved to an easily accessible location within the browser. Another method for accessing previously accessed pages includes navigating browsing history. Browser history stores previously accessed web pages, allowing users to navigate the browser history to particular dates/times such that pages they accessed at those dates/times can be re-accessed.

### SUMMARY

Embodiments of the present disclosure include a method, computer program product, and system for browser search history management. A search initiated by a user within an internet browsing application using a search phrase can be detected. A similarity between the search phrase and each of one or more existing groups can be determined, each of the one or more existing groups including one or more saved web pages. An existing group of the one or more existing groups can be selected based on the determined similarity. A current browsed web page returned from the search can be obtained, and the current browsed web page can be added to the existing group.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 is a block diagram illustrating an example computing environment in which illustrative embodiments of the present disclosure can be implemented.

FIG. 2 is a block diagram illustrating another example computing environment in which illustrative embodiments of the present disclosure can be implemented.

FIG. 3 is a flow-diagram illustrating an example method for managing browser history using groups, in accordance with embodiments of the present disclosure.

FIG. 4 is a flow-diagram illustrating another example method for managing browser history using groups, in accordance with embodiments of the present disclosure.

FIG. 5 is a diagram illustrating group recommendations that may be recommended to a user in response to receiving a search term, in accordance with embodiments of the present disclosure.

FIG. 6 is a diagram illustrating a list of saved groups, in accordance with embodiments of the present disclosure.

FIG. 7 is a diagram illustrating selectable stacked group tabs, in accordance with embodiments of the present disclosure.

FIG. 8 is a diagram illustrating a cloud computing environment, in accordance with embodiments of the present disclosure.

FIG. 9 is a block diagram illustrating abstraction model layers, in accordance with embodiments of the present disclosure.

FIG. 10 is a high-level block diagram illustrating an example computer system that may be used in implementing one or more of the methods, tools, and modules, and any related functions, described herein, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of computing, and in particular, to browser search history management. While the present disclosure is not necessarily limited to such applications, various aspects of the disclosure can be appreciated through a discussion of various examples using this context.

Currently, within internet browsers, bookmarks are used to save frequently accessed and/or important websites/web pages. Upon navigating to a particular web page, the user can “bookmark” the page by clicking an icon such that the page is saved to an easily accessible location within the browser. Another method for accessing previously accessed pages includes navigating browsing history. Browser history stores previously accessed web pages, allowing users to navigate the browser history to particular dates/times such that pages they accessed at those dates/times can be re-accessed.

However, there are drawbacks to using each of these methods for accessing previously accessed web-pages. For example, bookmarks can become crowded as a result of too many pages being bookmarked, making it difficult for a user to locate/navigate to pages they have saved. This can be exacerbated due to the fact that multiple web pages belonging to a single website domain can be bookmarked. Similarly, it can be difficult to locate desired pages using browser history. Every page the user has previously navigated is stored in the order they are accessed (e.g., based on time stamps). As a result, it can be difficult for a user to locate pages they have visited hours, days, or weeks ago, as they must identify the page out of many automatically stored pages. As such, solutions are needed to improve access to, and organization of, previously accessed web-pages.

Aspects of the present disclosure relate to browsing search history management. A search initiated by a user within an internet browsing application using a search phrase can be detected. A similarity between the search phrase and each of one or more existing groups can be determined, each of the one or more existing groups including one or more saved web pages. An existing group of the one or more existing groups can be selected based on the determined similarity. A current browsed web page returned from the search can be obtained, and the current browsed web page can be added to the existing group.

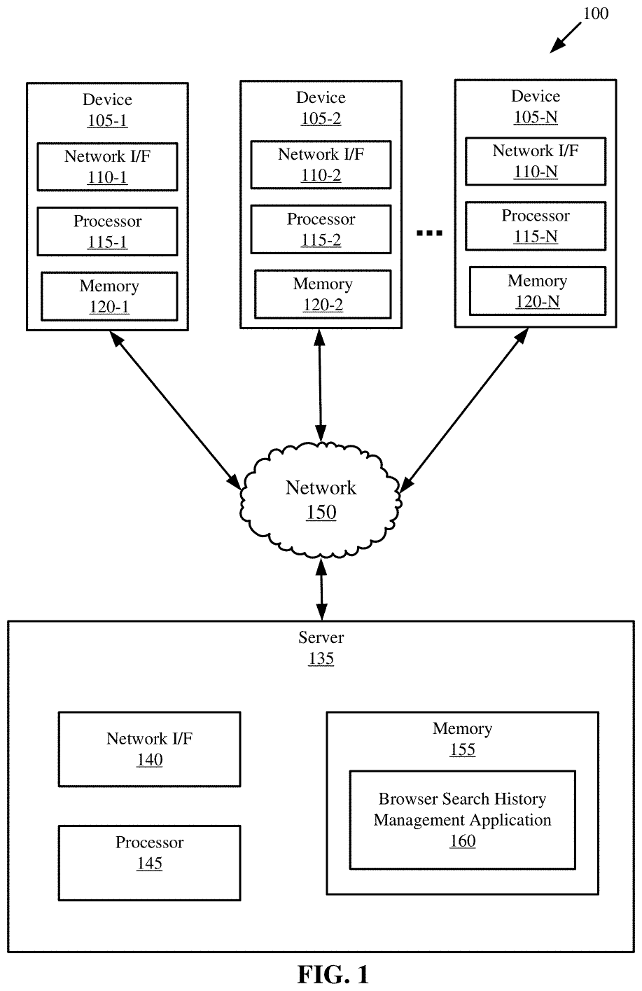

Turning now to the figures, FIG. 1 is a block diagram illustrating an example computing environment 100 in which illustrative embodiments of the present disclosure can be implemented. Computing environment 100 includes a plurality of devices 105-1, 105-2 . . . 105-N (collectively devices 105), at least one server 135, and a network 150.

The devices 105 and the server 135 include one or more processors 115-1, 115-2 . . . 115-N (collectively processors 115) and 145 and one or more memories 120-1, 120-2 . . . 120-N (collectively memories 120) and 155, respectively. The devices 105 and the server 135 can be configured to communicate with each other through internal or external network interfaces 110-1, 110-2 . . . 110-N (collectively network interfaces 110) and 140. The network interfaces 110 and 140 are, in some embodiments, modems or network interface cards. The devices 105 and/or the server 135 can be equipped with a display or monitor. Additionally, the devices 105 and/or the server 135 can include optional input devices (e.g., a keyboard, mouse, scanner, a biometric scanner, video camera, or other input device), and/or any commercially available or custom software (e.g., browser software, communications software, server software, natural language processing software, search engine and/or web crawling software, image processing software, etc.).

The devices 105 and the server 135 can be distant from each other and communicate over a network 150. In some embodiments, the server 135 can be a central hub from which devices 105 can establish a communication connection, such as in a client-server networking model. Alternatively, the server 135 and devices 105 can be configured in any other suitable networking relationship (e.g., in a peer-to-peer (P2P) configuration or using any other network topology).

In some embodiments, the network 150 can be implemented using any number of any suitable communications media. For example, the network 150 can be a wide area network (WAN), a local area network (LAN), an internet, or an intranet. In certain embodiments, the devices 105 and the server 135 can be local to each other and communicate via any appropriate local communication medium. For example, the devices 105 and the server 135 can communicate using a local area network (LAN), one or more hardwire connections, a wireless link or router, or an intranet. In some embodiments, the devices 105 and the server 135 can be communicatively coupled using a combination of one or more networks and/or one or more local connections. For example, the first device 105-1 can be hardwired to the server 135 (e.g., connected with an Ethernet cable) while the second device 105-2 can communicate with the server 135 using the network 150 (e.g., over the Internet).

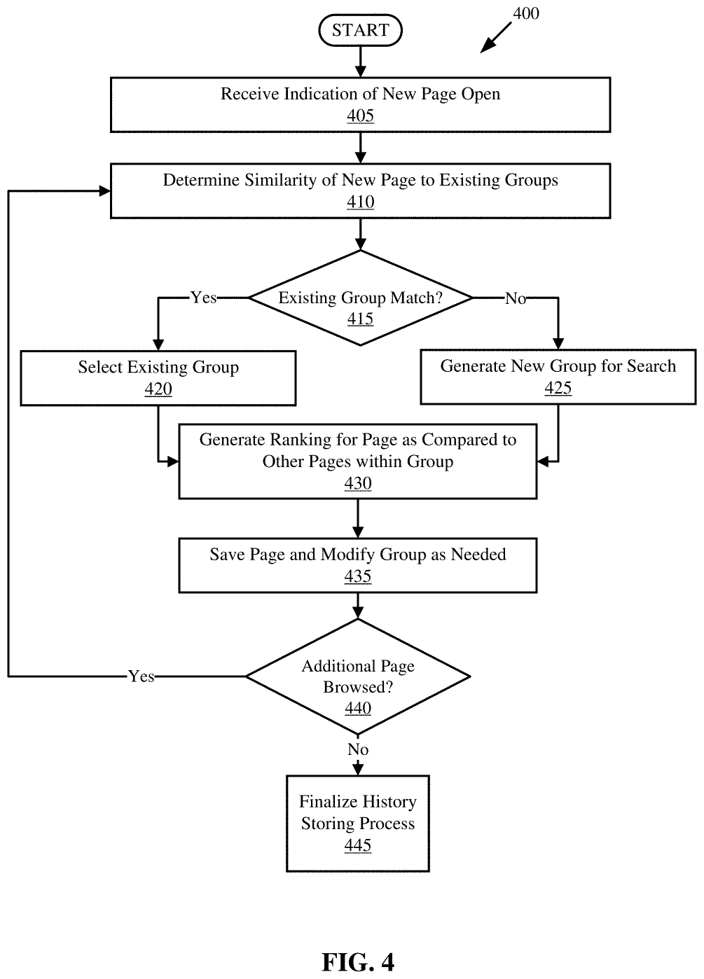

In some embodiments, the network 150 is implemented within a cloud computing environment or using one or more cloud computing services. Consistent with various embodiments, a cloud computing environment can include a network-based, distributed data processing system that provides one or more cloud computing services. Further, a cloud computing environment can include many computers (e.g., hundreds or thousands of computers or more) disposed within one or more data centers and configured to share resources over the network 150. In some embodiments, the network 150 may be substantially similar to, or the same as, cloud computing environment 50 described in FIG. 4.

The server 135 includes a browser search history management application 160. The browser search history management application 160 can be configured to detect searches completed by a user and automatically store browsed pages into groups accessible by the user. Groups can include one or more stored web pages which have been determined to be substantially similar (e.g., using natural language processing techniques). The web pages associated with a given group can then be ranked and ordered within the group according to predefined criteria. The groups can be accessible to the user in future browsing sessions such that the user can access all web pages within each respective group.

The browser search history management application 160 can first be configured to determine whether a user has initiated a new search (e.g., by receiving an indication of a search phrase entered into a search engine with returned search results). A determination can be made whether the search phrase (e.g., one or more words used to execute a search) is substantially similar to any existing groups. Determining whether the search phrase is substantially similar to any existing groups can be completed in any suitable manner (e.g., natural language processing (NLP) based similarity techniques). If a determination is made that the search phrase matches an existing group (e.g., a similarity threshold is satisfied), then the existing group is selected. If a determination is made that the search phrase does not match an existing group (e.g., a similarity threshold is not satisfied), then a new group is created and selected for the search phrase.

Upon selecting the existing group or creating and selecting the new group, a current browsed page that was returned as a search result is obtained. The current browsed page is then ranked as compared to other pages within the group based on one or more predefined criteria (e.g., the time spent browsing the page, relevance, search rank, number of times the page was previously opened, URL length, etc.). Upon ranking the page, the page is saved to the group and the group is updated. For example, one or more pages can be removed from the group, the label of the group can be changed, the pages ordered within the group can be reordered, etc. Thereafter, additional pages browsed from the initial search phrase results can be browsed and added to the group as necessary. The user can then select the group and browse from web pages listed within the group in future searches.

It is noted that FIG. 1 is intended to depict the representative major components of an example computing environment 100. In some embodiments, however, individual components can have greater or lesser complexity than as represented in FIG. 1, components other than or in addition to those shown in FIG. 1 can be present, and the number, type, and configuration of such components can vary.

While FIG. 1 illustrates a computing environment 100 with a single server 135, suitable computing environments for implementing embodiments of this disclosure can include any number of servers. The various models, modules, systems, and components illustrated in FIG. 1 can exist, if at all, across a plurality of servers and devices. For example, some embodiments can include two servers. The two servers can be communicatively coupled using any suitable communications connection (e.g., using a WAN, a LAN, a wired connection, an intranet, or the Internet). For example, in some embodiments, the browser search history management application 160 can be located on devices 105, or rather can be distributed across server 135 and devices 105. As an example, natural language processing (NLP) capabilities may reside on the server 135 while other aspects of the present disclosure may be located on devices 105. However, any suitable configuration can be implemented.

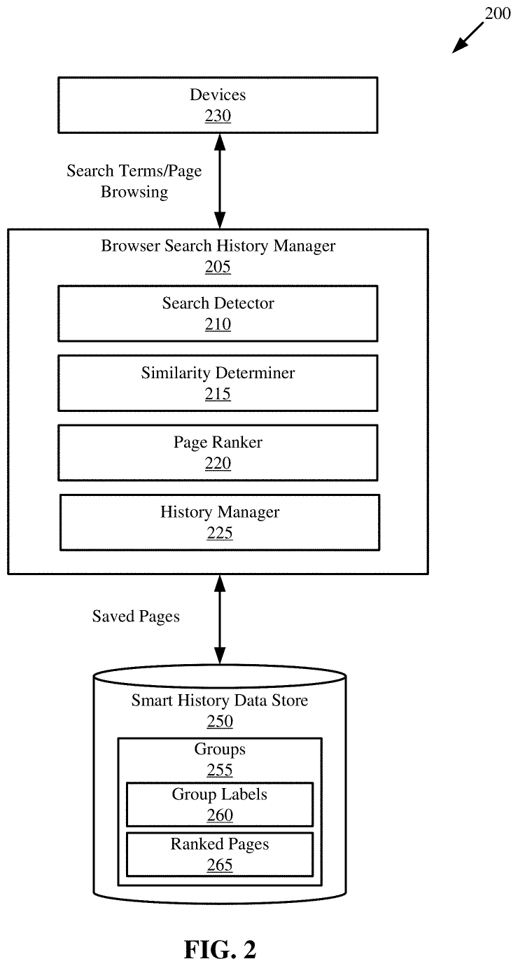

Referring now to FIG. 2, shown is a diagram illustrating an example computing environment 200 in which illustrative embodiments of the present disclosure may be implemented. The environment includes a browser search history manager 205 (e.g., browser search history management application 160) communicatively coupled to devices 230 (e.g., devices 105) and a smart history data store 250. The various components illustrated in FIG. 2 can be communicatively coupled by a network (e.g., network 150 of FIG. 1).

The browser search history manager 205 includes a search detector 210, a similarity determiner 215, a page ranker 220, and a history manager 225. The search detector 210, similarity determiner 215, page ranker 220, and history manager 225 can be processor executable instructions that can be executed by a dedicated or shared processor using received inputs. In embodiments, the components illustrated within environment 200 may be implemented within a web browser (e.g., a software application configured to access/manage communications through the Internet).

The smart history data store 250 includes groups 255. Each group 255 within the smart history data store 250 may have a designated group label 260, which may be manually generated or automatically generated based on one or more pages within each group 255. Further, one or more ranked pages 265 may be included in each group, allowing a user of a device 230 to navigate various pages within a group 255. The web pages included in each group 255 can be dynamic, and may be updated based on user activity (e.g., whether and how often web pages are utilized within each group). For example, infrequently accessed web pages within a given group can be removed from the group, web pages found to be no longer relevant to a given group can be removed from the group, etc. Web pages can be associated with each group 255 based on similarity calculated by the similarity determiner 215.

The search detector 210 can be configured to detect searches completed by devices 230. In particular, the search detector 210 can be configured to determine whether a device 230 has initiated a search (e.g., using a search engine, a hyperlink, etc.) on the Internet. Further, in embodiments, the search detector 210 can be configured to identify and store pages browsed based on returned searches. In embodiments, the search detector 210 can store metrics associated with browsed pages such as, for example, the number of times a browsed page has been opened, the amount of time spent browsing page, the time at which pages are browsed, etc.

The similarity determiner 215 can be configured to determine the similarity between a search phrase and one or more stored groups 255 within the smart history data store 250. In some embodiments, the similarity determiner 215 can determine the similarity between a browsed page and one or more stored groups 255. This can be completed in examples where browsed pages are not returned based on search results, but rather may be retrieved as directly accessed by a user (e.g., via a uniform resource locator (URL)). Similarity between a search phrase (or web page) and one or more stored groups 255 can be completed in any suitable manner. In some embodiments, a similarity score can be calculated between the search phrase and each of the one or more existing groups 255 based on text associated with the search phrase and each of the one or more existing groups 255. For example, text of the search phrase (e.g., or a currently browsed web page) can be compared to text included in the one or more existing groups 255 (e.g., within web pages stored within the existing groups) to determine similarity.

Similarity can be determined in any suitable manner. In some embodiments, NLP-based text similarity techniques can be utilized to determine similarity between the search phrase and the existing groups. For example, one or more word embedding techniques (e.g., word2vec, tf-idf, etc.) can be used to generate numerical data for each word, and a similarity function (e.g., based on cosine similarity, Euclidean distance, Jaccard distance, etc.) can be used to compare the generated numerical data (e.g., vectors). Thereafter, a decision function (e.g., comparison to one or more thresholds) can be used to determine whether the search phrase (or web page) and the groups 255 are substantially similar.

Thus, in embodiments, text preprocessing (e.g., removing of special characters, HyperText Markup Language (HTML) tags, format conversion, etc.) of textual data associated with the search phrase (or web page) and the one or more existing groups 255 can be completed (e.g., to normalize the text). Thereafter, feature extraction (e.g., encoding) can be completed such that numerical data (e.g., vectors) can be generated based on the text associated with each the search phrase and the one or more existing groups 255. Thereafter, a similarity function can be applied to determine the similarity (e.g., a similarity score) between the embeddings generated for the search phrase (or web page) and the one or more existing groups 255. Lastly, a decision function (e.g., comparison to one or more thresholds) can be implemented to determine whether the search phrase and the one or more existing groups 255 are substantially similar based on the calculated similarity. In some embodiments, if two or more groups are determined to be substantially similar to the search phrase (e.g., multiple groups satisfy the similarity threshold), then a group with the highest similarity can be selected as the most similar group.

It is noted that any suitable text-processing techniques (e.g., reformatting, image to text conversion, etc.), any suitable feature extraction techniques (e.g., word2vec, tf-idf, etc.), any suitable similarity determination techniques (e.g., cosine similarity, Euclidean distance, Jaccard distance, Dice Coefficient, Simpson coefficient, etc.), and any suitable decision function techniques (e.g., comparison to one or more thresholds) can be implemented without departing from the spirit and scope of the present disclosure.

Upon identifying a group that is similar to the search phrase, web pages browsed based on the search phrase can be ranked within the group by page ranker 220. Thus, web pages browsed based on the search result can be added to ranked pages 265 of a given group 255. Page ranker 220 can rank web pages browsed based on the search result in any suitable manner. In some embodiments, a time spent browsing can be determined for each web page within a given group and the order of the web pages within the group can be ranked based on the time spent browsing (e.g., where a first ranked page has a highest browsing time and a last ranked page has a lowest browsing time). In some embodiments, a number of times a web page has been opened can be determined for each web page within a given group and the order of the web pages within the group can be ranked based on the number of times each web page has been browsed (e.g., where a first ranked page has a highest number of times being opened and where a last ranked page has a lowest number of times being opened).

In some embodiments, relevance to the selected group can be used to determine ranking order. For example, similarity of text within the web page can be compared to the text of the group label 260 of a group to determine relevance, and the ranking can be completed based on the relative relevance as compared to other ranked pages within the group. In some embodiments, ranking can depend on the length of URL's associated with each web page, where longer length URL's have lower rankings. This can be completed as domain addresses (likely with shorter URL's) may be likely to be more relevant to a user than specific web pages. In some embodiments, ranking order within the group can be based on search result order returned from one or more search engines from which the page was extracted. Thus, if a search is completed and five web pages are added to a given group 255 based on the initial search, then the five pages can be ordered according to the order in which they were returned as search results. However, any other suitable manner for ranking web pages within a group can be completed.

In some embodiments, multiple factors can be collectively considered when determining page ranking. For example, scores for each of a plurality of weighted factors can be determined, and a total ranking score can be generated by adding up the weighted factor scores. As an example, a first weighted score based on page browsing time can be calculated, a second weighted score based on the number of times the page has been opened can be calculated, and a third weighted score based on relevance can be calculated for a first page. The three weighted scores can be added to arrive at a final ranking.

For example, the final ranking can be calculated according to: Ranking=f_{1w1}+f_{2w2}+f_{3w3} . . . +f_{nwn}. Following the example above, assume a first weight corresponding to time spent browsing is 0.35, a second weight corresponding to a number of times the page was opened is 0.30, and a third weight corresponding to relevance to the group is 0.35. Further assume that a score calculated for time spent browsing is 0.75, a score calculated based on a number of times the page was opened is 0.40, and a score calculated based on relevancy is 0.35. In this example, the final ranking for the page would be calculated as Ranking=0.75×0.35+0.40×0.30+0.35×0.35=0.505. Thus, a ranking of 0.505 can be compared to other pages within the group and the pages within the group can be ordered accordingly (e.g., in descending order, ascending order, etc.). The above-method for page ranking is merely exemplary, and any other suitable method for determining page ranking within a group can be implemented without departing from the spirit and scope of the present disclosure.

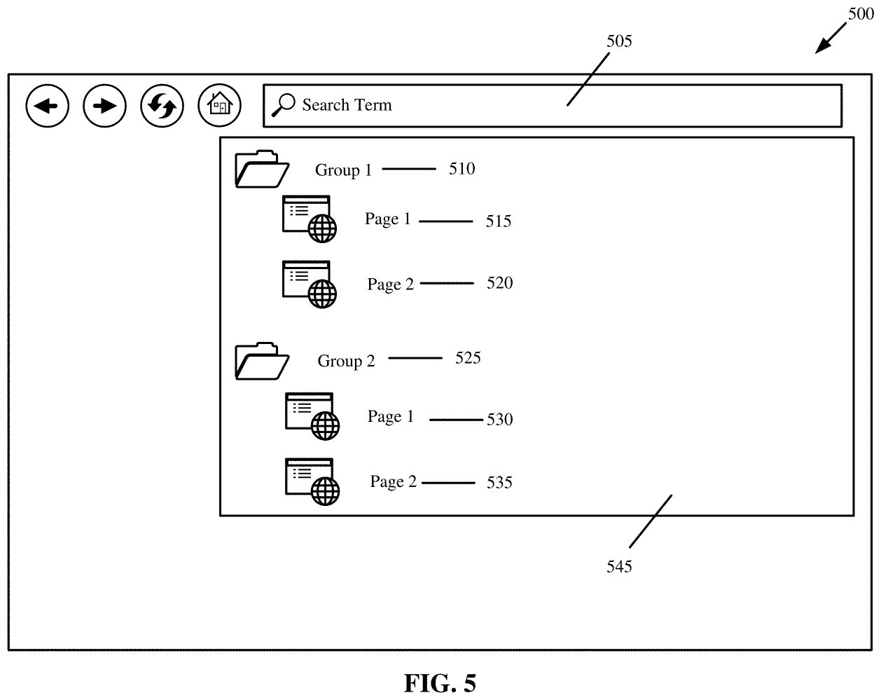

The history manager 225 of the browser search history manager 205 can be configured to update groups 255 based on newly ranked pages. For example, the history manager can be configured to add and/or remove pages from each group, relabel group labels 260 associated with groups based on added and/or removed pages, order groups presented to a user, and the like. For example, in some embodiments, history manager 225 can remove pages falling below a given similarity score or ranking score from a given group. In embodiments, the history manager 225 can be configured to present groups 255 to a user in a manner similar to as shown in FIGS. 5-7.

It is noted that FIG. 2 is intended to depict the representative major components of an example computing environment 200. In some embodiments, however, individual components can have greater or lesser complexity than as represented in FIG. 2, components other than or in addition to those shown in FIG. 2 can be present, and the number, type, and configuration of such components can vary.

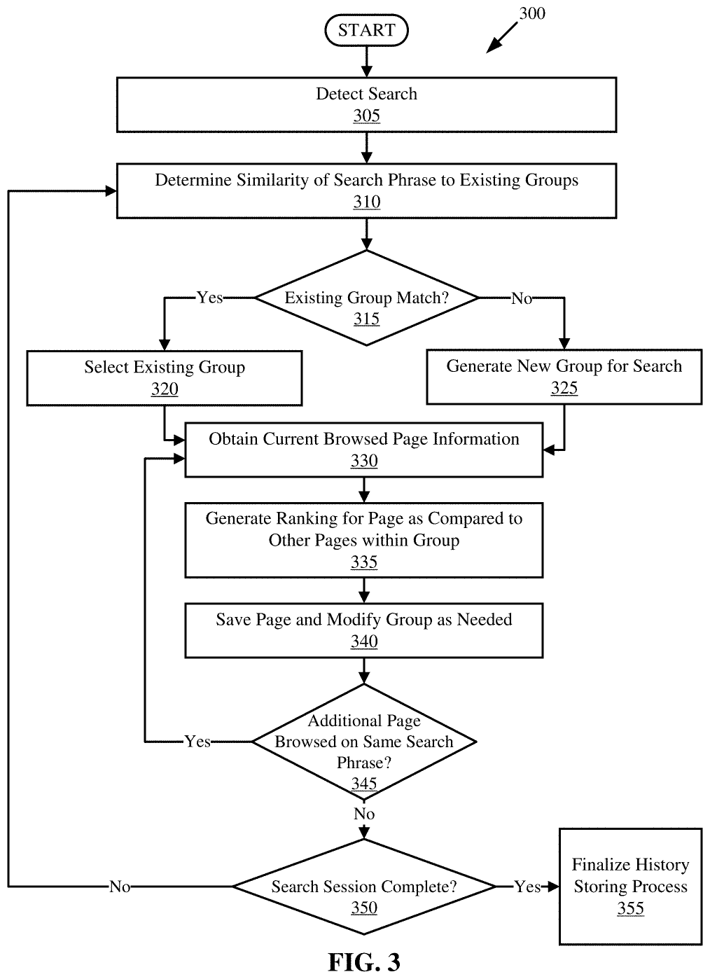

Referring now to FIG. 3, shown is a flow-diagram of an example method 300 for managing browsing history using groups, in accordance with embodiments of the present disclosure. One or more operations of method 300 can be completed by one or more processing devices (e.g., server 135, devices 105, devices 230, browser search history manager 205).

Method 300 initiates at operation 305, where a search is detected. The search can be completed by a device over a network using an internet browser. In embodiments, the search can be executed using a search engine (e.g., a software system designed to carry out web searches). In embodiments, detecting the search can include extracting a search phrase used to carry out the search.

A similarity of the search phrase to existing groups is determined. This is illustrated at operation 310. Determining similarity between the search phrase and one or more existing groups can be completed in the same, or a substantially similar manner, as described with respect to the similarity determiner 215 of FIG. 2. For example, pre-processing of text (e.g., formatting, removing non-uniform characters, etc.), feature extraction (e.g., word embedding/vectorization), and similarity determination (e.g., based on Jaccard Distance, Euclidean distance, cosine similarity, etc.), can be implemented to determine similarity between the search phrase and each of the one or more existing groups. In embodiments, the similarity can be quantified as a number between 0 and 1. However, any other suitable manner for quantifying similarity between the search phrase and each of the one or more existing groups can be determined.

A determination is made whether there is a match between an existing group and the search phrase. This is illustrated at operation 315. Determining whether there is a match to an existing group can be completed based on a threshold analysis. For example, if a similarity between a search phrase and a first group is 0.75, and a similarity threshold used to dictate a group match is set to 0.70, then the search phrase and first group can be determined to match based on the similarity of 0.75 exceeding the similarity threshold of 0.70. In embodiments, if two or more group matches are identified, then a group having the highest similarity to the search phrase can be selected.

If a determination is made that there is an existing group match, then the existing group is selected. This is illustrated at operation 320. If a determination is made that there is not an existing group match, then a new group is generated for the search phrase. This is illustrated at operation 325. In embodiments, the new group can be named after the search phrase (e.g., or a normalized version of the search phrase).

A current browsed page based on the searched phrase is obtained. This is illustrated at operation 330. A ranking is then generated for the current browsed page as compared to other pages within the group. This is illustrated at operation 335. Generating the ranking for the current browsed page can be completed in the same, or a substantially similar method, as described with respect to the page ranker 220 of FIG. 2. For example, the current browsed page can be ranked based on criteria such as time browsing (e.g., display time of the browsed page), number of times the browsed page was opened (e.g., the number of times the URL is retrieved for the browsed page), relevance, etc.

The page is then saved to the group and the group is modified as necessary. This is illustrated at operation 340. In embodiments, the order of pages in the group can be updated based on the newly added page and the group label of the group can be renamed based on the newly added page.

A determination is made whether there are additional pages browsed based on the same search phrase. This is illustrated at operation 345. If a determination is made that additional pages are browsed based on the same search phrase, then method 300 returns to operation 330, where a current browed page is obtained. Thus, method 300 may loop between operations 330 and 345 until all pages browsed on the same search phrase are ranked/added to the selected or generated group.

If a determination is made that an additional page is not browsed on the same search phrase, then a determination is made whether the search session is complete. This is illustrated at operation 350. Determining whether the search session is complete can be completed based on whether additional searches (with new search phrases) are completed. If additional searches are detected, then a determination is made that the search session is not complete, and method 300 can return to operation 310 where the similarity between the new search phrase and one or more existing groups can be determined. Thus, method 300 can loop between operations 310 and 350 for each new search phrase entered. If a determination is made that the search session is complete, then the history storing process is finalized. This is illustrated at operation 355. Finalizing the history storing processing can include rearranging groups with respect to one another, rearranging pages within groups (e.g., based on rank), removing, merging, or adding groups, removing and/or adding pages to groups, and relabeling groups.

The aforementioned operations can be completed in any order and are not limited to those described. Additionally, some, all, or none of the aforementioned operations can be completed, while still remaining within the spirit and scope of the present disclosure.

Referring now to FIG. 4, shown is a flow-diagram of an example method 400 for managing browsing history using groups, in accordance with embodiments of the present disclosure. One or more operations of method 400 can be completed by one or more processing devices (e.g., server 135, devices 105, devices 230, browser search history manager 205).

Method 400 initiates at operation 405, where an indication of a new page being open is received. Thus, in contrast with operation 305 of FIG. 3, rather than a search being executed (e.g., within a search engine), a new web page can be directly accessed (e.g., via a URL).

A similarity of the new web page to existing groups is determined. This is illustrated at operation 410. Determining similarity between the web page and one or more existing groups can be completed in the same, or a substantially similar manner, as described with respect to the similarity determiner 215 of FIG. 2. For example, pre-processing of text (e.g., formatting, removing non-uniform characters, etc.), feature extraction (e.g., word embedding/vectorization), and similarity determination (e.g., based on Jaccard Distance, Euclidean distance, cosine similarity, etc.), can be implemented to determine similarity between the web page and each of the one or more existing groups. In embodiments, the similarity can be quantified as a number between 0 and 1. However, any other suitable manner for quantifying similarity between the search phrase and each of the one or more existing groups can be determined. For example, in embodiments, similarity between the URL of the newly opened page and the existing pages stored within the group can be determined. Thus, in embodiments, text associated with the new page (e.g., the URL, text content, etc.) and text associated with the one or more existing groups (e.g., and pages referenced therein) can be compared to determine similarity at operation 410.

A determination is made whether there is a match between an existing group and the new page. This is illustrated at operation 415. Determining whether there is a match to an existing group can be completed based on a threshold analysis. In embodiments, if two or more group matches are identified, then a group having the highest similarity to the new page can be selected.

If a determination is made that there is an existing group match, then the existing group is selected. This is illustrated at operation 420. If a determination is made that there is not an existing group match, then a new group is generated for the newly opened page. This is illustrated at operation 425. In embodiments, the new group can be named based on the new page. For example, text (e.g., a title) can be extracted from the new page and used as a label designated for the generated group.

A ranking is then generated for the new page as compared to other pages within the group. This is illustrated at operation 430. Generating the ranking for the current browsed page can be completed in the same, or a substantially similar method, as described with respect to the page ranker 220 of FIG. 2. For example, the current browsed page can be ranked based on criteria such as time browsing (e.g., display time of the browsed page), number of times the browsed page was opened (e.g., the number of times the URL is retrieved for the browsed page), relevance, etc. In embodiments, if the group is new and there are no other pages, ranking may not be performed. In some embodiments, even if there are no other pages within the group, then a ranking score may still be generated for later use (when one or more pages are added to the group in the future).

The page is then saved to the group and the group is modified as necessary. This is illustrated at operation 435. In embodiments, the order of pages in the group can be updated based on the newly added page and the group label of the group can be renamed based on the newly added page.

A determination is made whether there are additional pages browsed. This is illustrated at operation 440. If a determination is made that additional pages are browsed, then method 400 returns to operation 410, where a similarity between the new page and existing groups is determined. Thus, method 400 may loop between operations 410 and 440 until all newly browsed pages are added to corresponding groups and ranked.

If a determination is made that there are no additional pages being browsed, then the history storing process is finalized. This is illustrated at operation 445. Finalizing the history storing processing can include rearranging groups with respect to one another, rearranging pages within groups (e.g., based on rank), removing, merging, or adding groups, removing and/or adding pages to groups, and relabeling groups.

Referring now to FIG. 5, shown is a diagram 500 illustrating an example group recommendation based on an entered search term, in accordance with embodiments of the present disclosure. The elements within FIG. 5 may be displayed on a graphical user interface (GUI) of a device. In particular, the elements within FIG. 5 may be displayed as part of an internet browser application in response to a user entering a search term. The elements within FIG. 5 may be generated using the components described with respect to FIGS. 1-2 and/or the methods described with respect to FIGS. 3-4.

As shown in FIG. 5, a search bar 505 is used to execute a search using a search term. In response to receiving the search term within search bar 505, a recommendation window 545 may be presented to the user. The recommendation window 545 may include a first group 510 and a second group 525 recommended to the user based on similarity between the search term and the first group (a first similarity) and based on a similarity between the search term and the second group (a second similarity). In this example, the first similarity may be higher than the second similarity and thus, the first group 510 may be displayed to the user at the top of the list as compared to the second group 525. Further, a first page of the first group 515 and a second page of the first group 520 may be displayed to the user as (indented) results within the first group 510. Similarly, a first page of the second group 530 and a second page of the second group 535 can be displayed to the user as (indented) results within the second group 525. Thus, the user can be automatically directed to saved groups similar to a search term they are intending on searching. This can allow the user to select groups/pages determined to be similar to their search term. In embodiments, if the user selects (e.g., clicks) a group and/or page, the user can be directed to the corresponding group and/or page.

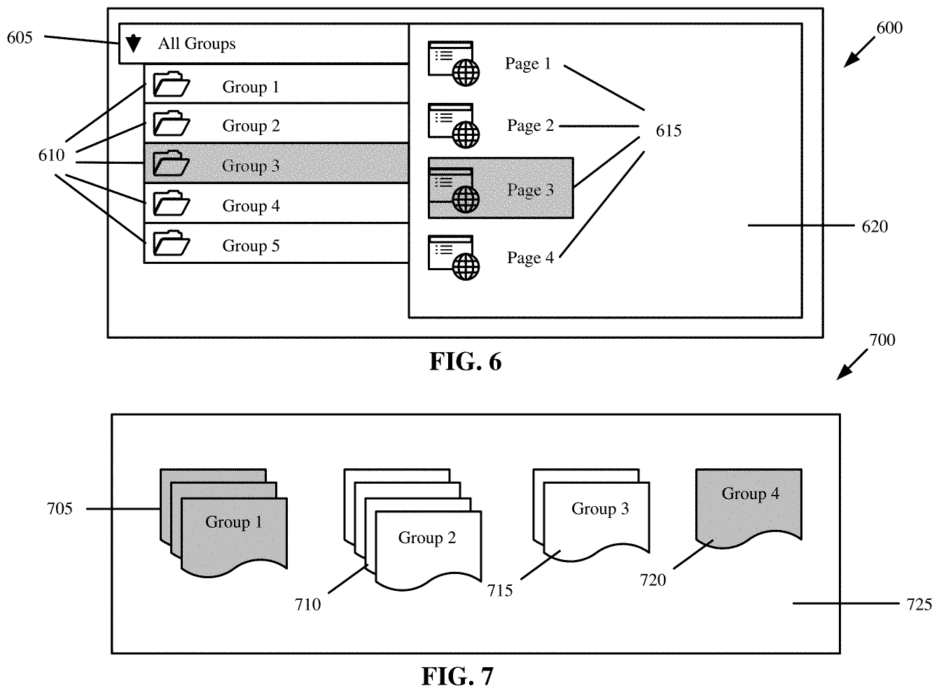

Referring now to FIG. 6, shown is a diagram 600 illustrating a list of groups, in accordance with embodiments of the present disclosure. The elements within FIG. 6 may be displayed on a graphical user interface (GUI) of a device. In particular, the elements within FIG. 6 may be displayed as part of an internet browser application as a selectable option for viewing currently saved groups and corresponding pages associated with each respective group. Further, the elements within FIG. 6 may be generated using the components described with respect to FIGS. 1-2 and/or the methods described with respect to FIGS. 3-4.

As shown in FIG. 6, a main groups tab 605 allows for the display of all existing groups 610. Each of the existing groups 610 may have a group label and may be selectable. As shown in FIG. 6, Group 3 is selected (as highlighted) and a list of pages 615 associated with Group 3 are displayed on the right in a web page window 620. Page 3 (highlighted) is selected within the web page window 620. After selecting the Page 3 within the web page window 620, an internet browser may direct a user to a URL associated with Page 3.

Referring now to FIG. 7, shown is a diagram 700 illustrating selectable group icons, in accordance with embodiments of the present disclosure. The elements within FIG. 7 may be displayed on a graphical user interface (GUI) of a device. In particular, the elements within FIG. 7 may be displayed as part of an internet browser application as a selectable option for viewing and selecting currently saved groups. The elements within FIG. 7 may be generated using the components described with respect to FIGS. 1-2 and/or the methods described with respect to FIGS. 3-4.

As shown in FIG. 7, a group tabs window 725 displays a list of group icons. The group icons can be stacked based on the number of pages associated with each group. For example, a first group 705 has three stacks and thus is associated with three web pages, a second group 710 has four stacks and thus is associated with four web pages, a third group 715 has two stacks and thus is associated with two web pages, and a fourth group 720 has a single stack and thus is only associated with a single web page. In this example, highlighted groups may indicate one or more pages currently being viewed within each respective group. Thus, pages are currently opened for the first group 705 and the fourth group 720 based on the highlighted icons. In embodiments, the group tabs window 725 can be opened in response to a particular user input (e.g., “CTRL+Tab”) while an internet browsing application is open. Selecting a group may allow access to URL links within each respective group, or may automatically open currently open web pages associated with highlighted groups.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

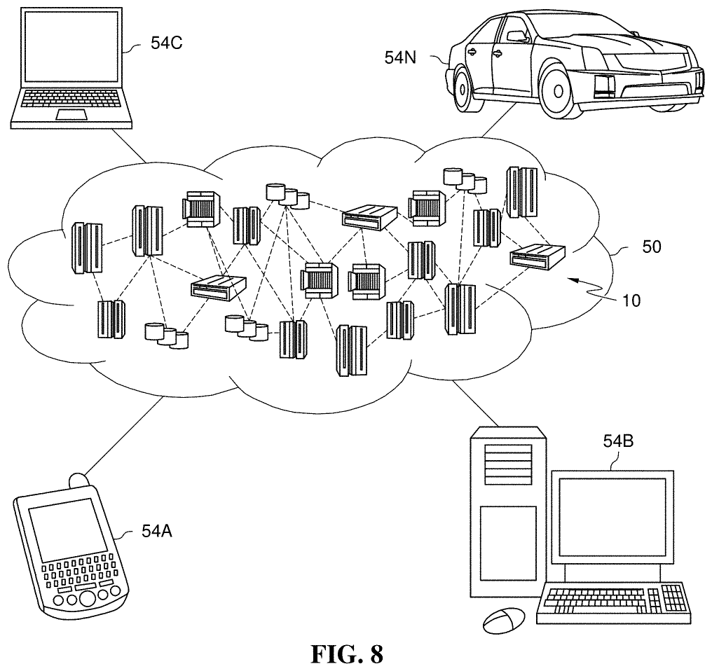

Referring now to FIG. 8, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A (e.g., devices 105), desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

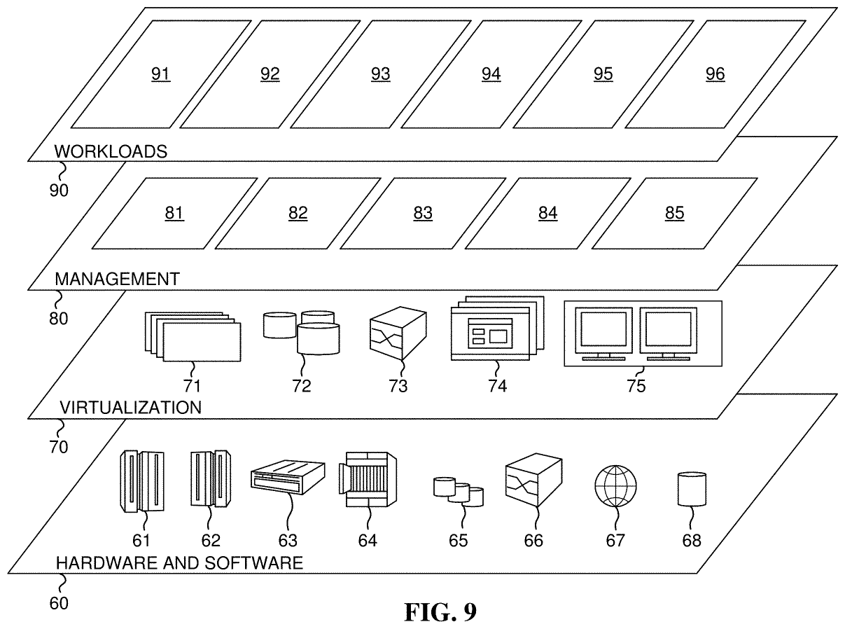

Referring now to FIG. 9, a set of functional abstraction layers provided by cloud computing environment 50 (FIG. 8) is shown. It should be understood in advance that the components, layers, and functions shown in FIG. 9 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and browsing history management 96.

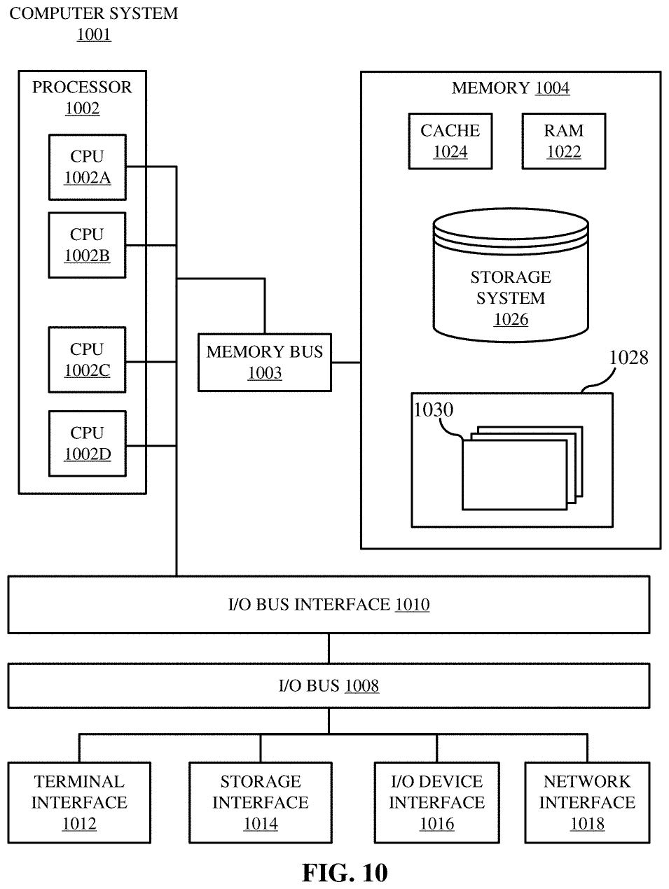

Referring now to FIG. 10, shown is a high-level block diagram of an example computer system 1001 (e.g., devices 105 and server 135) that may be used in implementing one or more of the methods, tools, and modules, and any related functions, described herein (e.g., using one or more processor circuits or computer processors of the computer), in accordance with embodiments of the present disclosure. In some embodiments, the major components of the computer system 1001 may comprise one or more CPUs 1002, a memory subsystem 1004, a terminal interface 1012, a storage interface 1014, an I/O (Input/Output) device interface 1016, and a network interface 1018, all of which may be communicatively coupled, directly or indirectly, for inter-component communication via a memory bus 1003, an I/O bus 1008, and an I/O bus interface unit 1010.

The computer system 1001 may contain one or more general-purpose programmable central processing units (CPUs) 1002A, 1002B, 1002C, and 1002D, herein generically referred to as the CPU 1002. In some embodiments, the computer system 1001 may contain multiple processors typical of a relatively large system; however, in other embodiments the computer system 1001 may alternatively be a single CPU system. Each CPU 1002 may execute instructions stored in the memory subsystem 1004 and may include one or more levels of on-board cache.

System memory 1004 may include computer system readable media in the form of volatile memory, such as random access memory (RAM) 1022 or cache memory 1024. Computer system 1001 may further include other removable/non-removable, volatile/non-volatile computer system storage media. By way of example only, storage system 1026 can be provided for reading from and writing to a non-removable, non-volatile magnetic media, such as a “hard-drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 1004 can include flash memory, e.g., a flash memory stick drive or a flash drive. Memory devices can be connected to memory bus 1003 by one or more data media interfaces. The memory 1004 may include at least one program product having a set (e.g., at least one) of program modules that are configured to carry out the functions of various embodiments.

One or more programs/utilities 1028, each having at least one set of program modules 1030 may be stored in memory 1004. The programs/utilities 1028 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 1028 and/or program modules 1030 generally perform the functions or methodologies of various embodiments.

Although the memory bus 1003 is shown in FIG. 10 as a single bus structure providing a direct communication path among the CPUs 1002, the memory subsystem 1004, and the I/O bus interface 1010, the memory bus 1003 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 1010 and the I/O bus 1008 are shown as single respective units, the computer system 1001 may, in some embodiments, contain multiple I/O bus interface units 1010, multiple I/O buses 1008, or both. Further, while multiple I/O interface units are shown, which separate the I/O bus 1008 from various communications paths running to the various I/O devices, in other embodiments some or all of the I/O devices may be connected directly to one or more system I/O buses.

In some embodiments, the computer system 1001 may be a multi-user mainframe computer system, a single-user system, or a server computer or similar device that has little or no direct user interface, but receives requests from other computer systems (clients). Further, in some embodiments, the computer system 1001 may be implemented as a desktop computer, portable computer, laptop or notebook computer, tablet computer, pocket computer, telephone, smart phone, network switches or routers, or any other appropriate type of electronic device.

It is noted that FIG. 10 is intended to depict the representative major components of an exemplary computer system 1001. In some embodiments, however, individual components may have greater or lesser complexity than as represented in FIG. 10, components other than or in addition to those shown in FIG. 10 may be present, and the number, type, and configuration of such components may vary.

As discussed in more detail herein, it is contemplated that some or all of the operations of some of the embodiments of methods described herein can be performed in alternative orders or may not be performed at all; furthermore, multiple operations can occur at the same time or as an internal part of a larger process.

The present disclosure can be a system, a method, and/or a computer program product. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But, the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

1. A method comprising:
detecting a search initiated by a user within an internet browsing application using a search phrase;
determining a similarity between the search phrase and each of one or more existing groups, each of the one or more existing groups including one or more saved web pages, wherein determining the similarity includes:
generating, using a word embedding technique, numerical data for each word of the search phrase and each word of the one or more existing groups;
comparing the numerical data between each word of the search phrase and each word of the one or more existing groups using a similarity function; and
applying a decision function to determine the similarity based on the comparing;
selecting, based on the determined similarity, an existing group of the one or more existing groups;
obtaining a current browsed web page returned from the search; and
adding the current browsed web page to the existing group.

2. The method of claim 1, further comprising:
ranking the current browsed web page with respect to one or more saved web pages within the existing group; and
saving the current browsed web page within an ordered list of saved web pages within the existing group based on the ranking.

3. The method of claim 2, wherein the ranking is determined based on a time spent browsing the current browsed web page as compared to the one or more additional saved web pages within the existing group.

4. The method of claim 2, wherein the ranking is determined based on a number of times the current browsed web page has been opened as compared to the one or more additional saved web pages within the existing group.

5. The method of claim 1, wherein the similarity between the search phrase and one or more existing groups is determined based on a natural language processing (NLP) based text similarity analysis.

6. The method of claim 1, further comprising:
detecting a second search initiated by the user within the internet browsing application using a second search phrase; and
recommending the existing group to the user based on a second similarity between the second search phrase and the existing group.

7. The method of claim 1, further comprising:
relabeling the existing group based on text extracted from the current browsed web page.

8. A system comprising:
one or more processors; and
one or more computer-readable storage media storing program instructions which, when executed by the one or more processors, are configured to cause the one or more processors to perform a method comprising:
detecting a search initiated by a user within an internet browsing application using a search phrase;
determining a similarity between the search phrase and each of one or more existing groups, each of the one or more existing groups including one or more saved web pages, wherein determining the similarity includes:
generating, using a word embedding technique, numerical data for each word of the search phrase and each word of the one or more existing groups;
comparing the numerical data between each word of the search phrase and each word of the one or more existing groups using a similarity function; and
applying a decision function to determine the similarity based on the comparing;
selecting, based on the determined similarity, an existing group of the one or more existing groups;
obtaining a current browsed web page returned from the search; and
adding the current browsed web page to the existing group.

9. The system of claim 8, wherein the method performed by the processor further comprises:
ranking the current browsed web page with respect to one or more saved web pages within the existing group; and
saving the current browsed web page within an ordered list of saved web pages within the existing group based on the ranking.

10. The system of claim 9, wherein the ranking is determined based on a time spent browsing the current browsed web page as compared to the one or more additional saved web pages within the existing group.

11. The system of claim 9, wherein the ranking is determined based on a number of times the current browsed web page has been opened as compared to the one or more additional saved web pages within the existing group.

12. The system of claim 8, wherein the similarity between the search phrase and one or more existing groups is determined based on a natural language processing (NLP) based text similarity analysis.

13. The system of claim 8, wherein the method performed by the processor further comprises:
detecting a second search initiated by the user within the internet browsing application using a second search phrase; and
recommending the existing group to the user based on a second similarity between the second search phrase and the existing group.

14. The system of claim 8, wherein the method performed by the processor further comprises:
relabeling the existing group based on text extracted from the current browsed web page.

15. A computer program product comprising one or more computer readable storage media, and program instructions collectively stored on the one or more computer readable storage media, the program instructions comprising instructions configured to cause one or more processors to perform a method comprising:
detecting a search initiated by a user within an internet browsing application using a search phrase;
determining a similarity between the search phrase and each of one or more existing groups, each of the one or more existing groups including one or more saved web pages, wherein determining the similarity includes:
generating, using a word embedding technique, numerical data for each word of the search phrase and each word of the one or more existing groups;
comparing the numerical data between each word of the search phrase and each word of the one or more existing groups using a similarity function; and
applying a decision function to determine the similarity based on the comparing;
selecting, based on the determined similarity, an existing group of the one or more existing groups;
obtaining a current browsed web page returned from the search; and
adding the current browsed web page to the existing group.

16. The computer program product of claim 15, wherein the method performed by the processor further comprises:
ranking the current browsed web page with respect to one or more saved web pages within the existing group; and
saving the current browsed web page within an ordered list of saved web pages within the existing group based on the ranking.

17. The computer program product of claim 16, wherein the ranking is determined based on a time spent browsing the current browsed web page as compared to the one or more additional saved web pages within the existing group.

18. The computer program product of claim 16, wherein the ranking is determined based on a number of times the current browsed web page has been opened as compared to the one or more additional saved web pages within the existing group.

19. The computer program product of claim 15, wherein the similarity between the search phrase and one or more existing groups is determined based on a natural language processing (NLP) based text similarity analysis.

20. The computer program product of claim 15, wherein the method performed by the processor further comprises:
detecting a second search initiated by the user within the internet browsing application using a second search phrase; and
recommending the existing group to the user based on a second similarity between the second search phrase and the existing group.
